(19) United States
(12) Patent Application Publication
(10) Pub. No.: US 2009/0323777 A1
(43) Pub. Date: Dec. 31, 2009

(54) Methods and Apparatus for Sharing Signal Correlation Data in a Receiver

(76) Inventors: Yi-Pin Eric Wang, Cary, NC (US); Hakan B. Bjorkegren, Taby (SE); Gregory E. Bottomley, Cary, NC (US)

Correspondence Address: COATS & BENNETT, PLLC, 1400 Crescent Green, Suite 300, Cary, NC, 27518, US

(21) Appl. No.: 12/147,260

(22) Filed: Jun. 26, 2008

(51) Int. Cl. H04B 1/707; H04B 1/10

(52) U.S. Cl. 375/148; 375/346; 375/E01.02

(57) ABSTRACT

Methods and apparatus are disclosed for suppressing both own-cell and other-cell interference in the processing of multiple signals of interest in a received composite signal. In an exemplary embodiment of the methods disclosed herein, combining weights for each of a first plurality of signals of interest in a composite information signal are computed, based on first shared signal correlation data computed from the composite information signal. A reduced-interference composite signal is calculated from the composite information signal, using, for instance, subtractive interference cancellation or interference projection techniques. Combining weights for processing each of a second plurality of signals of interest are computed as a function of second shared signal correlation data corresponding to the reduced-interference composite signal. Corresponding apparatus, including G-Rake and chip equalizer embodiments are also disclosed.

### TECHNICAL FIELD

The present invention generally relates to wireless communication systems, and particularly relates to the processing of multiple signals in a received composite information signal using shared signal correlation data.

### BACKGROUND

In certain types of wireless communication networks, the received signal at a given network base station comprises a received composite signal that includes signals of interest from a plurality of mobile terminals (“users”) being supported by the base station. As one example, many users in a Code Division Multiple Access (CDMA) network may simultaneously transmit on the uplink to a supporting base station. That base station receives all of these signals of interest together as a composite information signal, along with any number of interfering signals, and recovers each individual signal of interest by, for example, correlating the composite signal with the unique uplink scrambling code of each user. Similarly, in the downlink, a mobile terminal receives signals transmitted simultaneously from a plurality of multiple base stations.

Indeed, a common aspect of such processing is the correlation of the received composite signal with each user's (or base station's) scrambling code at different code (delay) offsets, to obtain multipath versions of each user's signal of interest. As is well known, these multipath versions can be combined to obtain signal-to-noise ratio (SNR) improvements. In a basic combining system, such as in the well known “Rake” receiver architecture, each signal of interest is de-spread by a plurality of Rake “fingers” positioned at delay offsets corresponding to the (primary) multipath propagation delays of the signal. A combining circuit then combines the finger output signals using combining weights determined from the complex channel coefficient estimated for each delay path.

Rake processing in the above manner yields SNR improvements for each signal of interest in additive white Gaussian noise (AWGN) conditions, i.e., in the absence of colored interference bearing on the signals of interest. Where spectrally biased interference is present, which is a common phenomenon in existing and developing wireless communication networks, more sophisticated combining weights are needed to provide “whitening” of the combined signal. To this end, linear equalization receivers, such as “Generalized Rake” (G-Rake) receivers and chip equalizer (CE) receivers, use combining weights that consider the effects of colored interference. However, the computation of these more sophisticated combining weights is not trivial, and generally involves potentially burdensome computations arising from the generation of correlation estimates for each signal of interest. These correlation estimates provide the basis for the computation of whitening combining weights.

In more detail, the received composite signal at a CDMA base station consists of a number of desired signals from users in the base station's own coverage area (cell/sectors), and a number of interfering signals from users in other cells. The other-cell interference may include high-rate, high-power signals, which may arise, for example, from a lack of user transmission scheduling coordination between cells. The presence of such high-power interfering signals will often result in considerable performance degradation to the signals of interest. Thus to improve system capacity and stability, it is desirable to suppress such high-power other-cell interfering signals.

Release 7 of the 3^{rd}-Generation Partnership Project (3GPP) Universal Mobile Telecommunications System (UMTS) specifications introduced new modulation schemes, including 16-level Quadrature Amplitude Modulation (16-QAM), for use in Wideband Code-Division Multiple Access (W-CDMA) uplink transmissions. These changes enable peak data rates of almost 12 megabits-per-second (Mbps). Permitting transmission at these high data rates in real multi-user networks will cause difficult (and unprecedented) interference situations for base stations tasked with decoding transmissions from several simultaneous users.

Other-cell interfering signals may not be in the active set for the base station, so that the receiver would have little information about them. In such situations, one approach to demodulating desired signals includes suppressing other-cell interference using a nonparametric form of G-Rake receiver processing. For own-cell interference, which may include other-cell users in the active set that are in a soft handover state, more complicated forms of interference suppression may be used, including subtractive interference cancellation (SIC) or interference projection techniques. However, SIC processing takes time, adding latency to the end-to-end data processing, and may not provide benefits for certain signals.

In the prior art, a number of approaches to processing multiple user signals in a receiver have been proposed. Several of these have focused on subtractive interference cancellation techniques. For instance, in U.S. Patent Application Publication 2006/0240794, “Method and Apparatus for Canceling Interference from High Power, High Data Rate Signals,” by Cozzo et al., a subtractive interference cancellation approach is proposed for suppressing own-cell, high-rate signals. In one disclosed solution, high-rate signals are detected using a G-Rake receiver. The detected signals are then regenerated and subtracted from the received composite signal. Finally, the remaining low-rate signals are detected using Rake or G-Rake processing techniques. In U.S. Patent Application Publication 2005/0195889, “Successive Interference Cancellation in a Generalized RAKE Receiver Architecture,” by Grant et al., a Successive Interference Cancellation/G-Rake approach is proposed for detecting Multiple-Input Multiple-Output (MIMO) High-Speed Packet Access (HSPA). In the Grant publication, each MIMO transmit antenna sends one data stream. At the receiver, a first data stream is detected using a G-Rake receiver. The detected signal is regenerated and subtracted from the received composite signal. At this point, the impairment correlations corresponding to the received composite signal are revised to reflect the reduced interference level. The combining weights for G-Rake processing of the second stream are derived based on the revised impairment correlations. This process may be repeated until all the data streams are detected.

In U.S. Patent Application Publication 2007/0189363, “Reduced Complexity Interference Suppression for Wireless Communications,” by Eriksson et al., an interference suppression approach is disclosed in which computations for G-Rake formulations for multiple users are based on shared data. Specifically, chip sample data correlations are formed and shared when forming G-Rake weights for different users.

The entire contents of each of the aforementioned publications, i.e., the Cozzo, Grant, and Eriksson publications, are incorporated by reference herein.

### SUMMARY

Methods and apparatus are disclosed for cost-effectively suppressing both own-cell and other-cell interference in the processing of multiple signals of interest in a received composite signal. In some embodiments of the invention, a nonparametric G-RAKE approach is used for suppressing other-cell interference. Chip sample data correlations are thus used to form combining weights for G-Rake processing; the data correlation data is shared among the processing of a first group of signals included in the composite signal. In various embodiments of the invention, the received composite signal is “improved,” for example by using subtractive interference cancellation to remove the effects of a demodulated high-rate signal. A second group of signals included in the composite signal is then processed based on shared signal correlation data corresponding to the improved signal. Accordingly, some signals, such as signals with strict latency requirements, may be processed before subtractive interference cancellation or other interference-reducing approach is employed, while other signals are processed afterwards. The signal correlation data used before and after the signal improvement differs, to reflect the difference between the received composite signal and the reduced-interference composite signal. Data correlations may be shared among processing of several user signals, to reduce complexity of the receiver.

Accordingly, in an exemplary embodiment of the methods disclosed herein, combining weights for each of a first plurality of signals of interest in a composite information signal are computed, based on first shared signal correlation data computed from the composite information signal. A reduced-interference composite signal is calculated from the composite information signal, using, for instance, subtractive interference cancellation or interference projection techniques. Combining weights for processing each of a second plurality of signals of interest are computed as a function of second shared signal correlation data corresponding to the reduced-interference composite signal. In some embodiments, the first plurality of signals of interest includes a high-data-rate signal, which is demodulated, regenerated (e.g.,by re-spreading detected bits of the demodulated signal to obtain a cancellation signal) and subtracted from the composite information signal to generate the reduced-interference composite signal. In other embodiments, the reduced-interference composite signal may be calculated from the composite information signal by projecting the composite information signal away from an interfering signal, using interference subspace rejection.

In some embodiments of the invention, the second shared signal correlation data corresponding to the reduced-interference composite signal is computed by calculating a shared data correlation matrix from the reduced-interference composite signal. In some of these embodiments, the shared data correlation matrix may be computed by calculating an impairment correlation matrix for a particular signal of interest in the reduced-interference composite signal and adding a signal-specific correction term. The impairment correlation matrix in these embodiments may be calculated by estimating impairment correlations from de-spread values of the signal of interest corresponding to one or more unused channelization codes of the signal of interest.

In other embodiments, the second shared signal correlation data may be computed from the first shared signal correlation data, rather than directly from the interference-reduced composite signal. In some of these embodiments, the second shared signal correlation data is calculated by compensating the first shared signal correlation data to reflect the reduction in interference in the reduced-interference composite signal. In embodiments where signal contributions of a demodulated signal are subtracted from the composite information signal to obtain the interference-reduced signal, this compensation of the first shared signal correlation data may comprise subtracting a data covariance term corresponding to the subtracted signal contributions.

Corresponding apparatus, e.g., wireless receiver systems, configured to carry out one or more of the methods described herein are also disclosed. In particular, some embodiments of a wireless receiver system include a first correlation calculator circuit configured to compute first shared correlation data from a composite information signal; one or more first receiver circuits configured to compute combining weights for each of a first plurality of signals of interest in the composite information signal, as a function of the first shared signal correlation data; and a signal improver circuit configured to calculate a reduced-interference composite signal from the composite information signal. These embodiments further include a second correlation circuit configured to compute second shared correlation data corresponding to the reduced-interference composite signal and one or more second receiver circuits configured to compute combining weights for each of a second plurality of signals of interest in the reduced-interference composite signal, as a function of the second shared signal correlation data.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a simplified block diagram of a wireless communication network, which may be, according to one or more embodiments taught herein, a CDMA-based network.

FIG. 2 is a block diagram of functional processing elements according to one embodiment of a wireless receiver system for use in a base station.

FIG. 3 is a logic flow diagram illustrating processing logic for processing multiple signals of interest in a composite information signal according to some embodiments of the invention.

FIG. 4 is a logic flow diagram illustrating an embodiment of processing logic for removing the contribution of a high-power signal from a composite information signal and computing shared signal correlation data corresponding to the resulting reduced-interference signal.

FIG. 5 is a graph of a data rate and/or received signal power threshold, which may be used according to some embodiments of the invention to form groups of signals of interest for processing.

FIGS. 6 and 7 are block diagrams of processing elements corresponding to Generalized Rake (G-Rake) and chip equalizer (CE) circuits.

### DETAILED DESCRIPTION

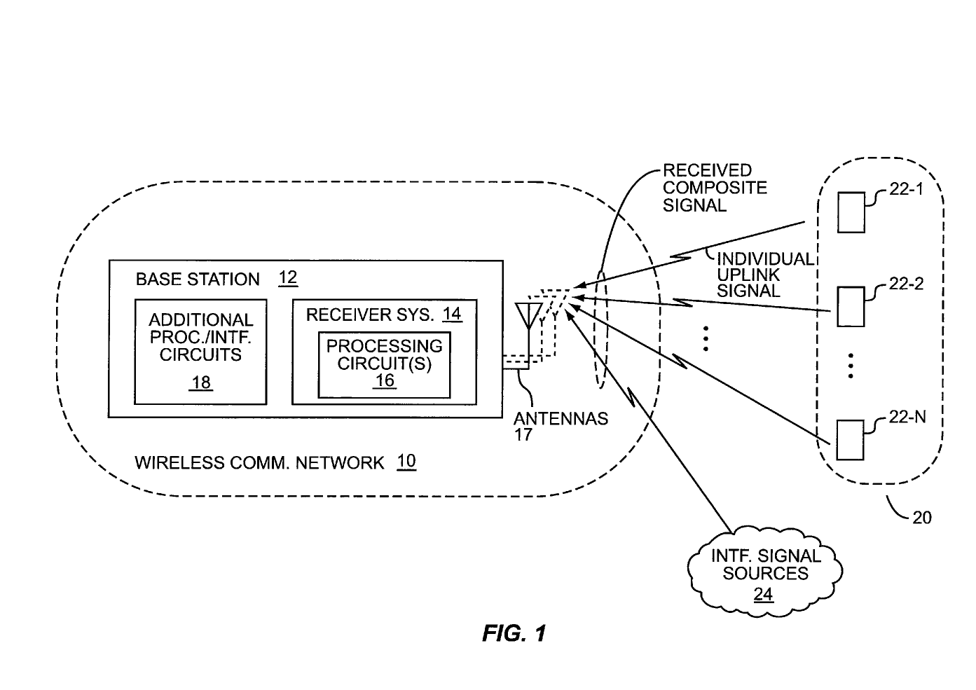

FIG. 1 is a simplified block diagram of one embodiment of a wireless communication network 10, which includes a base station 12 comprising a receiver system 14, including one or more processing circuit(s) 16. The base station 12 includes or is associated with one or more base station antenna and/or antenna elements 17, and further comprises additional processing/interface circuits 18 as appropriate for interfacing the base station 12 to one or more other network entities for performing communication call processing, etc. The wireless communication network 10 may comprise, as a non-limiting example, a Code Division Multiple Access (CDMA) network, e.g., a Wideband CDMA network, in which case base station 12 may comprise a CDMA base station.

Base station 12 provides service coverage, e.g., radio signal coverage, over one or more service regions, such as cells or sectors (not explicitly shown). The base station 12 receives a composite received signal on the uplink, which includes individual uplink signals from a plurality 20 of users being supported by the base station 12. In FIG. 1, the users are represented by individual mobile stations 22-1, 22-2, . . . , 22-N, each of which transmits at least one individual uplink signal that represents a signal of interest within the received composite information signal at the base station 12. The received composite signal at the base station 12 also includes interference from various interference sources 24, such as the uplink signals from users in other cells of the network 10, etc.

The receiver system 14 is configured to recover and process individual signals of interest from the received composite signal. This processing may include channel compensation and interference suppression in support of signal demodulation and decoding for the recovery of transmitted data from each signal of interest. The generation of combining weights (for each signal of interest) is one aspect of such processing, wherein the combining weights are used, for example, in linear equalization in G-Rake or CE implementations of the receiver system 14. Signal quality estimation is another aspect of such processing.

As will be discussed more fully below, the receiver system 14 is configured to obtain computational efficiencies by using shared correlation estimates in combining weight and signal quality computations, at least for some of the signals of interest in the composite information signal. For example, in one or more embodiments, the one or more processing circuits 16 of the receiver system 14 are configured to group the signals of interest into at least first and second groups. The one or more processing circuits 16 in these embodiments compute combining weights for each signal of interest in the first group as a function of shared correlation estimates. Signal quality can be estimated from the combining weights or directly from the correlation estimates.

In various embodiments, receiver system 14 is further configured to calculate an “improved” signal, i.e., a reduced-interference composite signal, from the composite information signal, and to determine second shared signal correlation data corresponding to the reduced-interference signal. This second shared signal correlation data may be used for, inter alia, computing combining weights for each signal of interest in the second group of signals of interest.

Broadly, the one or more processing circuits 16 comprise hardware, software, or any combination thereof. In at least one embodiment, they comprise at least one special- or general-purpose microprocessor circuit, where that term encompasses DSP-type processors. In such embodiments, the above-described operative configuration of the one or more processing circuits 16 may be obtained by, for example, provisioning a memory/storage device of the base station 12 with a computer program comprising program instructions corresponding to the described processing. Of course, it will be appreciated that it may be advantageous to implement at least a portion of the signal processing using dedicated hardware-based processing elements.

As suggested above, base station receivers require cost-effective solutions for suppressing both own-cell and other-cell interference. To suppress other-cell interference, a nonparametric G-Rake approach is needed, since the receiver generally has little information regarding the other-cell signals. One approach is thus to use chip-sample data correlations derived from the received composite signal to form the G-Rake weights; these data correlations may be shared among the processing of several signals of interest.

In some embodiments of the invention, the received signal is then improved in some way, to suppress own-cell interference. One example of an approach to suppressing own-cell interference prior to processing a particular signal of interest of group of signals is subtractive interference cancellation. This may be particularly useful when a very high rate signal is present. The high-rate user signal may be demodulated, regenerated, and subtracted from the received signal, forming an interference-reduced received signal. Another possible approach to “improving” the received composite information signal utilizes projection techniques, in which the received signal is projected away from an interfering signal. After the signal is improved, one or more additional signals of interest may be processed—in some embodiments, these signals may be processed using a different set of shared signal correlation data that corresponds to the improved signal.

Thus, in some embodiments of the invention, signals to be demodulated are divided into at least two groups. The first group corresponds to signals that are demodulated using the original received signal. These signals do not benefit from the interference-improved signal. Some signals may be assigned to the first group, for example, because they have strict delay or latency requirements. A very high rate, and thus high power, signal might also be assigned to the first group. The second group includes signals that are demodulated using the reduced-interference composite signal, i.e., the “improved” signal. In some embodiments, these signals may include the traffic channels of low-to-medium data rate users (including voice). The second group might also include any control signaling that does not have strict delay or latency requirements. and that can thus tolerate the extra delay incurred during the interference improvement process.

For G-Rake processing of these two groups of signals, data correlations are formed. For the first group, data correlations using the original received signal are formed and shared to determine signal-specific G-Rake combining weights for each signal of interest in the first group. For the second group, data correlations corresponding to the reduced-interference composite signal are formed and shared to determine signal-specific G-Rake combining weights for each signal of interest in the second group. This second set of shared correlations reflects a reduced interference level after the subtractive interference cancellation or other improvement of the composite information signal.

As will be described in more detail below, in some embodiments the second shared data correlations may be computed directly from the reduced-interference signal samples, while in others the second shared data correlations may be computed by modifying the first shared data correlations. In any event, those skilled in the art will appreciate that similar processes may be used in a chip equalizer implementation of the present invention to form equalizer combining weights for processing signals in the first and second groups of signals.

Signals in the first group may include one or more high-rate signals that are detected based on the initial version of the received signal. As noted above, the signals in the first group may further include time-critical control information that must be detected quickly, e.g., before a time-consuming subtractive interference cancellation process is performed. Signals in the second group may include medium-to-low rate users that are detected after cancelling out interference caused by high-rate signals. Signals in the second group might further include control signaling that does not have strict delay or latency requirements.

The shared signal correlation data used to process either or both groups of signals may be data correlations derived from chip samples of the composite information signal or the reduced-interference composite signal. As is well known to those skilled in the art, a chip-sample data correlation matrix may be formed from outer products of chip-level data for all processing delays of interest, e.g., according to:

$${\hat{R}}_{d} = \frac{1}{N} {\sum }_{m = 1}^{N} y ( m ) {y}^{H} ( m ) , \qquad ( 1 )$$

where y(n) is a vector of chips corresponding to the desired delays for chip n in the current processing slot. Again as is well known to those skilled in the art, the data correlation matrix \hat{R}_{d} may be used directly for computing combining weights for each of the signals of interest, provided that soft bit information is properly adjusted prior to decoding. Alternatively, an estimate of a signal-specific impairment correlation matrix for each signal of interest can be computed from \hat{R}_{d}, e.g., according to:

\hat{R}ᵤ=\hat{R}_{d}−ĥĥ^{H}, (2)

where ĥ it is an estimated net channel response for the signal of interest. G-Rake combining weights can then be formed for each signal of interest from the impairment correlation matrix according to:

w=\hat{R}ᵤ⁻¹ĥ. (3)

Those skilled in the art will understand that matrix inversion is not an absolute necessity for computing the combining weights, as the weights may be obtained through more computationally practical means such as the Gauss-Seidel algorithm.

Another form of sharing of signal correlation data can be based on impairment correlations estimated for a particular user of interest (UOI) in the group using unused codes. In this approach, codes that are not used by a particular uplink user are identified. These unused codes are de-spread with a given spreading factor for a set of processing delays. Outer products of the de-spread vectors xₙ(k) for each of n unused codes are computed and accumulated to obtain a user-specific impairment correlation matrix, e.g., according to:

$${\hat{R}}_{u , U O I} = \frac{1}{{N}_{code} {N}_{samples}} {\sum }_{n = 0}^{{N}_{code} - 1} {\sum }_{k = 0}^{{N}_{samples}} {x}_{n} ( k ) {x}_{n}^{H} ( k ) . \qquad ( 4 )$$

A correction term in the form of ĥ_{UOI}ĥ_{UOI}^{H} may then be added to the estimated impairment correlations, where ĥ_{UOI} is the net channel response for the user of interest. The corrected correlations,

\hat{R}_{d}=\hat{R}_{u,UOI}+ĥUOIĥ_{UOI}^{H}, (5)

may then be shared for processing of other signals in the group, such as for computing signal-specific combining weights.

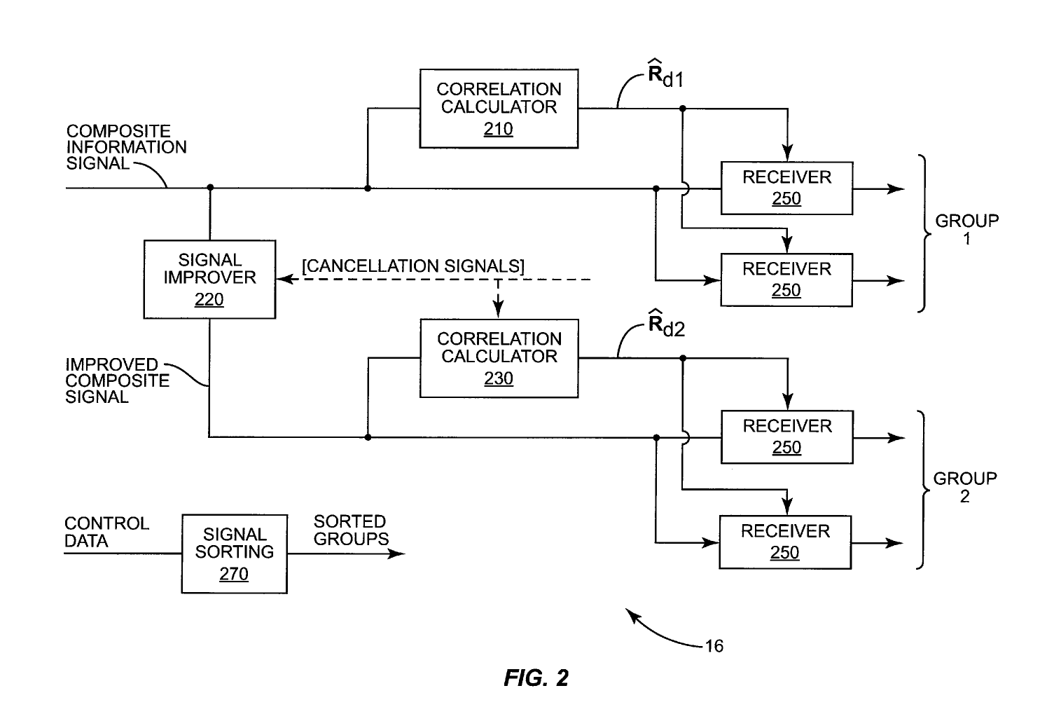

FIG. 2 illustrates functional blocks of a receiver architecture according to some embodiments of the invention. These functional blocks may be implemented, for example, using the processing circuits 16 of receiver system 14 in FIG. 1.

A composite information signal is used by correlation calculator 210 to calculate first shared signal correlation data \hat{R}_{d1}. This first shared signal correlation data is used by several receiver modules 250 to process individual signals from a first group of signals of interest in the composite information signal. As will be described in more detail below, each of the receiver modules 250 may comprise, for example, a G-Rake processing element or a chip equalizer processor element, such as those pictured in FIGS. 6 and 7. Thus, in some embodiments, each of the first group of receiver modules 250 is configured to detect a signal of interest (belonging to a pre-determined “Group 1”) from the composite information signal, using the first shared receive sample correlations \hat{R}_{d1} to formulate combining weights for processing each signal. Of course, receiver modules 250 may include other processing functions that utilize the first shared signal correlation data, including, for example, a signal quality estimation process. Not shown in FIG. 2 are other receiver system functional blocks that may be necessary to support the received signal processing in each of the receiver modules 250, such as channel estimation, finger placement or delay placement processing, etc. The details of such functions are known to those skilled in the art, and are not necessary to an understanding of the present invention.

In the receiver system of FIG. 2, the composite information signal is also applied to a signal improver 220, which yields an improved composite signal. As noted above, the signal improver 220 may comprise an interference cancellation circuit or other circuit configured to generate a revised, or reduced-interference composite signal. In some embodiments, signal improver 220 may comprise a subtractive interference cancellation circuit. In this case, signal improver 220 may subtract a cancellation signal from the composite information signal to produce the reduced-interference composite signal. The cancellation signal may be a regenerated (e.g., re-spread) signal produced by one of the receiver modules 250 processing signals from the first group of signals of interest.

The receiver then proceeds to detect the second group of the signals. At this point, revised receive sample correlations may be calculated, based on the cleaned-up version of the received signal. Note that these signals can be multidimensional, such as signals from different receive antennas.

In the pictured receiver system, the improved composite signal is used by correlation calculator 230 to calculate second shared signal correlation data \hat{R}_{d2}. This second shared signal correlation data is used by a second group of receiver modules 250 to process individual signals from a second group of signals of interest in the composite information signal. Again, each of the receiver modules 250 may comprise, for example, a G-Rake processing element or a chip equalizer processor element. Thus, in some embodiments, each of the second group of receiver modules 250 may be configured to detect a signal of interest (belonging to a pre-determined “Group 2”) from the composite information signal, using the second shared receive sample correlations \hat{R}_{d2} to formulate combining weights for processing each signal.

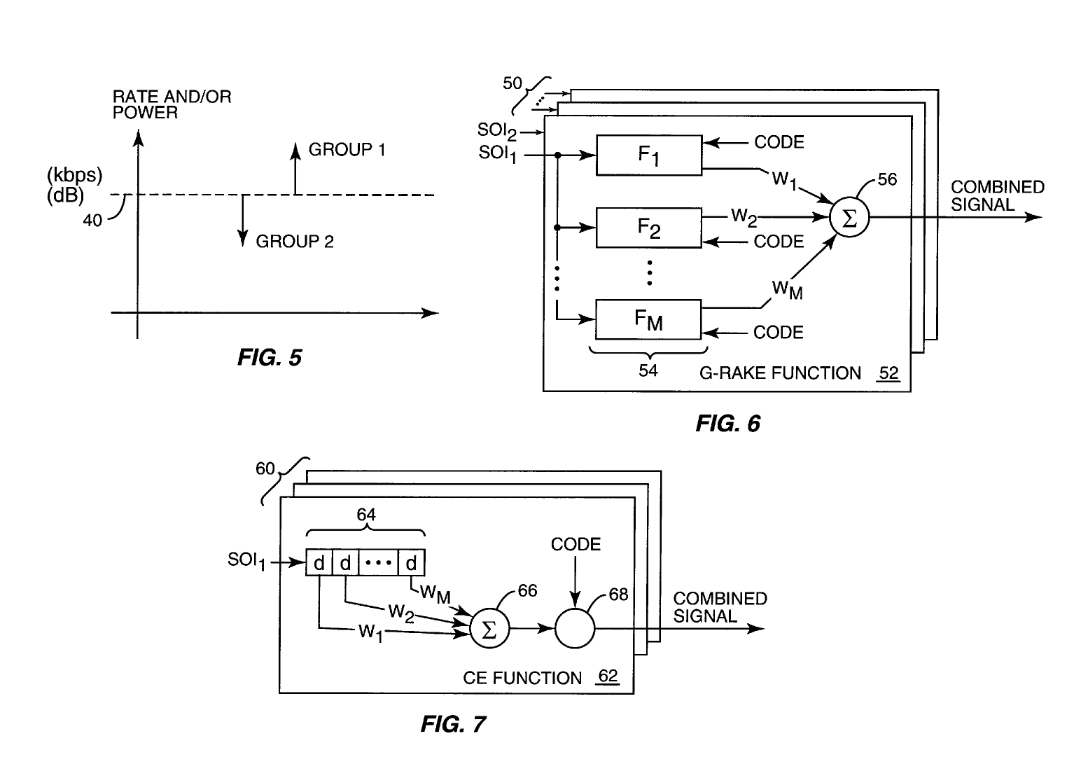

The receiver system of FIG. 2 further includes a signal sorting module 270. The function of this module is to determine which signals are to be detected (or otherwise processed) in the first group and which signals are to be detected in the second group. According to some embodiments, signals detected based on the initial version of the received signal (the composite information signal of FIG. 2) and using the first set of shared correlation values may include medium-to-high rate signals, including their control channels, and time-critical control channel information associated with low rate signals. Furthermore, signals detected based on the cleaned-up version of the received signal, e.g., the improved composite signal of FIG. 2, and using the second shared correlation values, may include medium-to-low rate signals and their non-time-critical control channel information. Thus, some embodiments of the invention may compare the data rate or power level of a signal of interest to a pre-determined threshold level to assign the signal of interest to the first or second groups, as shown in FIG. 5. A similar process might be used to assess the latency requirements associated with a particular signal of interest.

Those skilled in the art will appreciate that not all signals of interest in the received composite information signal are necessarily assigned to the first or second groups. For instance, in some instances, such as for very high-rate signals, impairment correlation data derived from unused codes (as described above) may be preferred to shared correlation data derived from received chip samples. Thus, in some embodiments, the sharing of receive sample correlations among the first group of signals may exclude one or more very high-rate signals that are processed using separately derived signal correlation data.

Furthermore, although it was suggested above that a cancellation signal used in signal improver 220 might be derived from one (or more) of the signals in the first group, this cancellation signal might also be derived from, for example, a very high-rate signal that was not part of group 1. Again, this signal might be detected instead using signal correlation data that is not shared, such as a signal-specific impairment correlation matrix derived using unused codes for the signal of interest.

Various approaches to grouping signals between the first and second groups are possible. For example, in some instances where a very high-rate signal is present, it may be desirable to detect as many signals as possible after the effects of the high-rate signal are cancelled using, for example, subtractive interference cancellation. Thus, in this case, the first group of users detected using the first shared version of receive sample correlations may include only the time-critical control channel information for all the active channels. After cancelling out the very-high rate signal, the second shared received sample correlations can be derived for detecting the other data signals, e.g., lower-rate data signals, voice signals, and non-time-critical control channel information.

According to yet another embodiment of the present invention, when a very high-rate signal is present, other medium-rate signals may be detected after cancelling out the very high-rate signal. Thus, in this case, the first group of users detected using the first shared version of receive sample correlations may include only the time-critical control channel information of all the active channels. After cancelling out the very-high rate signal, the interference-reduced composite signal can be used to estimate the second shared received sample correlations. The set of second shared receive sample correlations may then be used for detecting other medium-rate signals, including their non-time-critical control channel information (e.g., signals with rates higher than 2 Mbps but lower than 7 Mbps). These medium-rate signals may be further cancelled from the interference-reduced version of the signal after detection, to obtain another improved interference-reduced signal. This second interference-reduced signal may then be used to estimate third shared receive sample correlations for detecting the remaining signals of interest, including their non-time-critical control channel information. Thus, the techniques disclosed herein can be extended to more than two groups of signals of interest.

Control signaling in the W-CDMA uplink includes transmit power control (TPC) commands, transport format combination indicator (TFCI), enhanced transport format combination indicator (E-TFCI), feedback indicator (FBI), ACK/NACK, channel quality indicator (CQI), happy bit (HB), and retransmission sequence number (RSN). The TPC commands could be time-critical for users moving at high speed. Thus, in some embodiments TPC commands will be demodulated based on the first set of shared correlations. On the other hand, TPC commands could be non-time-critical for users moving at low speed. In this case, TPC commands might be demodulated based on the second set of shared correlations. Similarly, FBI, CQI can be either time-critical, or non-time-critical depending on the user mobility. Ack/Nack, TFCI, E-TFCI, HB and RSN are most likely non-time-critical and thus can be demodulated based on the second set of shared correlations. Thus, control signals associated with different users and/or different traffic channels might be processed in different groups, using different shared signal correlation data sets.

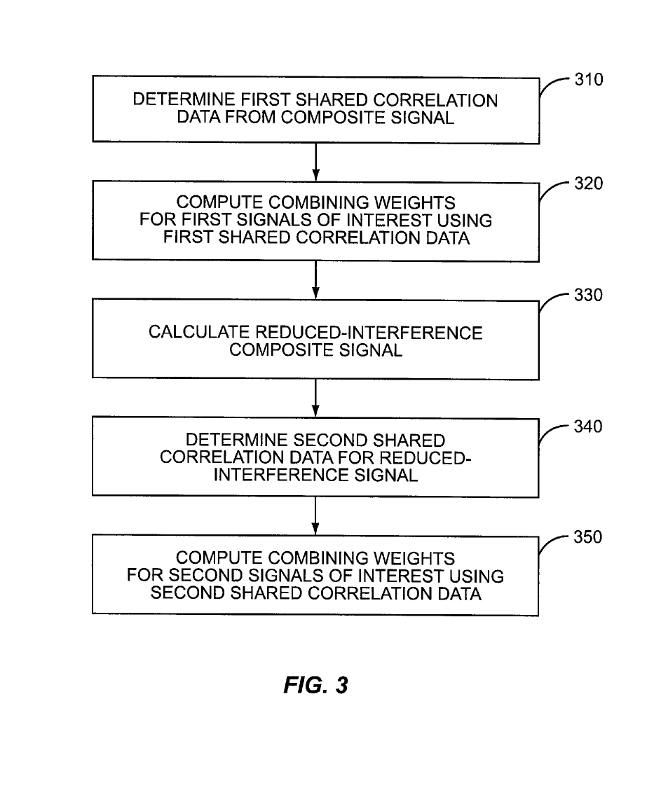

FIG. 3 illustrates a logic flow diagram for exemplary processing logic according to some embodiments of the invention. Those skilled in the art will appreciate that the process outlined in FIG. 3 may be implemented using receiver systems of various types, including, but not limited to, receivers employing G-RAKE processing, chip equalization, subtractive interference cancellation techniques, and/or interference projection techniques.

In any case, the processing flow of FIG. 3 begins at block 310, with the determination of first shared correlation data from a composite information signal containing several signals of interest. As noted above, in some embodiments the shared correlation data may comprise a chip sample data correlation matrix derived directly from chip-level samples of the composite information signal. In other embodiments, the first shared signal correlation data may comprise an impairment correlation matrix, such as an impairment correlation matrix derived from unused codes for a first signal of interest and corrected as described earlier.

At block 320, combining weights are computed for first signals of interest (e.g., signals belonging to a first group of signals of interest) using the first shared correlation data. In some embodiments, this computation process may comprise calculating an estimated signal-specific impairment correlation matrix for each signal from a shared data correlation matrix, and calculating the combining weights for each signal from the signal-specific impairment correlation matrix. In other embodiments, the combining weights may be computed directly from a shared data correlation matrix, with appropriate scaling applied to the resulting soft symbols. Those skilled in the art will appreciate that the combining weights may comprise combining weights for fingers of a G-Rake receiver element, in some embodiments, or chip equalizer combining weights in others.

At block 330, a reduced-interference composite signal is calculated from the composite information signal. In some embodiments, this may comprise subtractive interference cancellation, whereby the effects of one or more signals are removed from the composite information signal by subtracting regenerated versions of the one or more signals from the composite information signal. In other words, signal contributions of a demodulated signal may be subtracted from the composite information signal to obtain the reduced-interference composite signal. This may comprise re-spreading detected bits of the demodulated signal using the appropriate spreading code, to obtain a cancellation signal, and subtracting the cancellation signal from the composite information signal. In other embodiments, calculating the reduced-interference composite may comprise transforming the composite information signal data using interference projection techniques, such as interference subspace rejection, to effectively project interference away from one or more signals of interest.

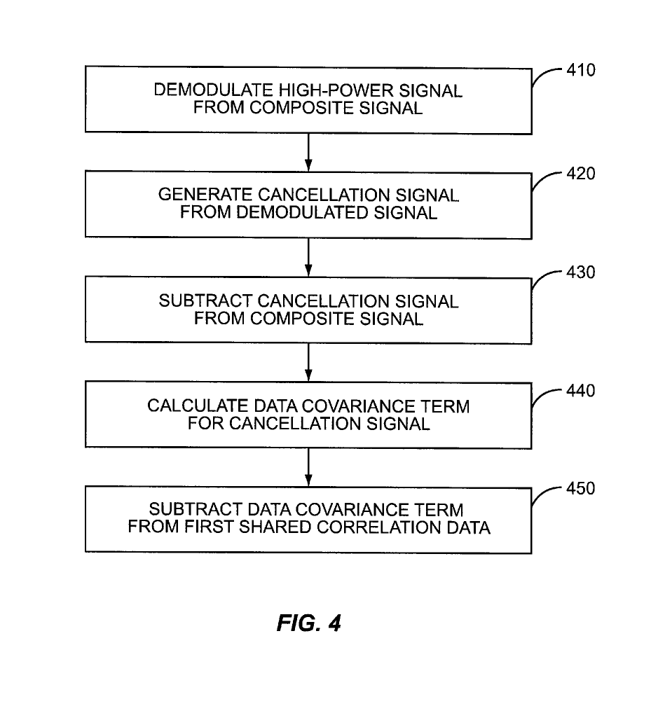

At block 340, second shared signal correlation data, corresponding to the interference-reduced signal, is determined. In some embodiments, the second shared signal correlation data may comprise a data correlation matrix calculated from samples of the interference-reduced composite signal. In others, the second shared signal correlation data may instead be computed by adjusting, or compensating, the first shared correlation data. One approach according to these latter embodiments is described in more detail below in connection with the description of FIG. 4.

At block 350, the second shared signal correlation data is used to process a second group of signals of interest, in this case to compute combining weights. As with the processing illustrated at block 320, this computation process may comprise calculating an estimated signal-specific impairment correlation matrix for each signal from a shared data correlation matrix, and calculating the combining weights for each signal from the signal-specific impairment correlation matrix. In other embodiments, the combining weights may be computed directly from a shared data correlation matrix, with appropriate scaling applied to the resulting soft symbols.

FIG. 4 illustrates further details of some embodiments of a processing logic flow according to the inventive techniques disclosed herein. The process illustrated in FIG. 4 may be employed for example, in situations where a high-power (high-rate) signal is demodulated, and its effects removed from the composite information signal to obtain the reduced-interference signal. Thus, the process of FIG. 4 begins at block 410 with the demodulation of the high-power signal from the composite information signal. This demodulation may be performed according to any of a variety of receiver processing schemes, including using the G-Rake and chip equalizer processors discussed herein. In some embodiments, the high-power signal may be demodulated using combining weights determined from shared signal correlation data. In other words, the high-power signal may be one of the first group of signals of interest discussed above. However, in other embodiments the high-power signal may be demodulated separately from the first group, using signal-specific signal correlation data derived separately from the first shared signal correlation data.

In any case, the processing flow illustrated in FIG. 4 continues at block 420, with the generation of a cancellation signal from the demodulated signal. This cancellation signal may be generated by re-spreading detected bits of the demodulated signal to obtain a cancellation signal that replicates the contributions of the originally transmitted signal to the composite information signal. Those skilled in the art will appreciate that the cancellation signal may be based on soft symbol values, i.e., detected but not decoded, or based on decoded bits that are re-encoded before the re-spreading operation.

At block 430, the cancellation signal is subtracted from the composite information signal to obtain an interference-reduced composite signal. More specifically, in some embodiments a reconstructed version of the demodulated signal is subtracted from a composite information signal r⁽¹⁾ to obtain a reduced-interference composite signal r⁽²⁾:

r⁽²⁾=r⁽¹⁾−h⁽¹⁾*s_{c}⁽¹⁾, (6)

where s_{c}⁽¹⁾ is the re-spread version of the symbols s⁽¹⁾ of the demodulated high-power signal, and * indicates convolution. Those skilled in the art will appreciate that removing the signal contribution from a dominant high-power signal may greatly reduce the own-cell interference caused by these signals, improving the efficiency and accuracy of subsequent detection of other signals of interest.

Blocks 440 and 450 illustrate processing steps for calculating second shared signal correlation data corresponding to the interference-reduced composite signal. As noted above, in some embodiments of the receiver systems and methods disclosed herein, the second shared signal correlation data may be calculated from the reduced-interference composite signal itself, e.g., by calculating a data correlation matrix from the reduced-interference composite signal samples. However, in the process flow illustrated in FIG. 4, the second shared signal correlation data is computed instead from the first shared signal correlation data, based on the cancellation signal used to generate the reduced-interference composite signal. Thus, the first shared signal correlation data is compensated to reflect the reduction in interference in the reduced-interference composite signal.

Accordingly, as shown at block 440, a data covariance term is computed for the cancellation signal. The data covariance term is then subtracted from the first shared signal correlation data to obtain the second shared signal correlation data, as shown at block 450. In more detail, in some embodiments, the effect of the demodulated signal is removed from the first shared data covariance matrix R_{d1} by subtracting a correction term Δ from R_{d1}. An exact expression of Δ is the data covariance of the reconstructed signal h⁽¹⁾*s_{c}⁽¹⁾, which is given in H. Hadinejad-Mahram, “On the equivalence of linear MMSE chip equalizer and generalized RAKE,” IEEE Commun. Letters, vol. 8, no. 1, January 2004. However, this is a rather complicated function of the channel h⁽¹⁾ (the net channel response for the demodulated signal), the channel taps, the receiver fingers, and the pulse shape. Also, in general, the data covariance matrix for the reconstructed signal has full rank, or close to it, making calculations more complex. Thus, various simplifying approximations may be used instead.

Accordingly, in some embodiments of the invention, the data covariance term Δ may be approximated as the outer product of h⁽¹⁾, that is:

\hat{Δ}=α⁽¹⁾h⁽¹⁾h^{(1)H}. (7)

Here the scaling parameter α⁽¹⁾ absorbs required adjustments, if any, such as accounting for the expected value of the modulation symbols, or the relative powers of control and data symbols. Using this approximation for the data covariance of the reconstructed signal, then the updated data covariance matrix R_{d2}, corresponding to the reduced-interference communication signal r⁽²⁾ becomes:

R_{d2}=R_{d1}−α⁽¹⁾h⁽¹⁾h^{(1)H}. (8)

Those skilled in the art will appreciate that the logic flow illustrated in FIG. 4 describes but one of several possible approaches to updating a signal correlation matrix to account for the removal of the signal contributions of one or more demodulated signals. Another approach, for example, is given in a co-pending patent application titled “Method and Apparatus for Successive Interference Subtraction with Covariance Root Processing,” U.S. patent application Ser. No. 12/103,145, filed Apr. 15, 2008, the contents of which are incorporated herein by reference.

As noted above, any or all of the signals of interest in the composite information signal and the reduced-interference composite signal may be demodulated using a variety of receiver technologies, including G-Rake processing and chip-level equalization. Accordingly, FIG. 6 illustrates a set 50 of G-Rake functions 52, each of which may be included, for example, in the receiver modules 250 of FIG. 2. Similarly, FIG. 7 illustrates a set 60 of comparable chip equalizer functions 62. Again, each of these chip equalizers 62 may be included in the receiver modules 250 of FIG. 2.

Although the basics of G-Rake processing and chip equalization are well known to those skilled in the art, a brief review of these technologies, as applied to the present invention, is provided here, beginning with the G-Rake receiver circuits 52 of FIG. 6, each of which can be used to process a given signal of interest included in the received composite signal.

Each G-Rake receiver circuit 52 includes a plurality of Rake fingers 54 (correlators) that allow one or more selected code channels to be de-spread from a signal of interest. Each Rake finger outputs a finger signal (de-spread values obtained from the signal of interest), and each finger signal is weighted by one of the combining weights (w₁, w₂, . . . , wₘ) from the corresponding vector of combining weights w determined for the signal of interest. A combining function 56 combines the weighted finger signals to produce a combined signal for further processing (e.g., decoding to recover transmitted data).

In various embodiments of the present invention, these combining weights are computed for each signal of interest in a first group using first shared signal correlation data corresponding to composite signal of interest. For each signal of interest in a second group, however, the combining weights are computed using second shared signal correlation data corresponding to a reduced-interference composite signal.) As discussed above, either of the shared signal correlation data may be computed by determining the correlations between samples of the composite information signal (or the reduced-interference composite signal) at delay differences (for certain sampling phases) corresponding to the delay and/or antenna differences between the Rake fingers 54. Thus, to the extent that the delay differences for a first signal of interest are partly or wholly the same as the delay differences for one or more other signals of interest in one or the other of the groups, the correlation estimates computed for those delay differences may be shared among the corresponding G-Rake functions 52.

Accordingly, correlation calculator 210 and correlation calculator 230 of FIG. 2 can be configured to generate a pool of shared correlation estimates covering all of the delay differences between the Rake finger delays of each G-Rake function 52 being used to process a signal of interest in the respective groups. To the extent that a given delay difference is applicable to more than one signal of interest, the correlation estimate determined for that delay difference can be shared among the G-Rake functions 52 of those signals of interest. Thus, in some embodiments of the invention, the pool of shared correlation estimates includes correlation estimates for all of the unique delay differences represented by the aggregate set of G-Rake functions 52 being used for processing the signals of interest in the second group.

FIG. 7 illustrates a comparable arrangement for processing the signals of interest included in the received composite signal, but one based on a chip equalizer receiver architecture rather than the above-described G-Rake receiver architecture. Thus, in some embodiments of the present invention, a receiver system may include a set 60 of chip equalizer functions 62, each of which can be used to process a given signal of interest. Each chip equalizer function 62 includes a serial delay register 64, a combining circuit 66, and a correlator 68. The delay register 64 provides an output tap at each delay stage, such that samples of the signal of interest may be taken at selected processing delays and weighted according to the combining weights (w₁, w₂, . . . , wₘ) from the corresponding vector of combining weights w determined for the signal of interest. Again, those combining weights are computed from first shared correlation data for signals of interest in the first group, and from second shared correlation data for signals of interest in the second group.

As with the finger delay differences in a G-Rake implementation, shared correlation estimates may be computed to cover all of the filter tap delay differences of each chip equalizer function 62. That is, the digital filtering determined for each signal of interest dictates the selection of tap outputs from a subset of delay stages in the delay register 64, and two or more of the signals of interest in the second group may share at least some of the same tap delay differences, meaning that they can share correlation estimates corresponding to those shared tap delay differences.

Broadly, the teachings of the present disclosure include various techniques for processing multiple signals of interest in a composite information signal, in which first shared signal correlation data, corresponding to the composite information signal, is used to process a first group of signals of interest and second shared signal correlation data, corresponding to a reduced-interference composite signal, is used to process a second group of signals in the reduced-interference composite signal. With the variations of the methods and apparatus described herein in mind, those skilled in the art will appreciate that the present invention is not limited by the foregoing discussion, nor is it limited by the accompanying drawings. Indeed, the present invention is limited only by the following claims, and their legal equivalents.

What is claimed is:

1. A method of processing multiple signals of interest in a composite information signal, the method comprising:
computing combining weights for each of a first plurality of signals of interest as a function of first shared signal correlation data computed from the composite information signal;
calculating a reduced-interference composite signal from the composite information signal; and
computing combining weights for each of a second plurality of signals of interest as a function of second shared signal correlation data corresponding to the reduced-interference composite signal.

2. The method of claim 1, wherein calculating a reduced-interference composite signal from the composite information signal comprises subtracting signal contributions of a demodulated signal from the composite information signal to obtain the reduced-interference composite signal.

3. The method of claim 2, wherein subtracting signal contributions of a demodulated signal from the composite information signal comprises re-spreading detected bits of the demodulated signal to obtain a cancellation signal, and subtracting the cancellation signal from the composite information signal.

4. The method of claim 2, wherein the demodulated signal is among the first plurality of signals of interest.

5. The method of claim 2, wherein the demodulated signal has a higher data rate than any of the first plurality of signals of interest and the second plurality of signals of interest.

6. The method of claim 1, wherein calculating a reduced-interference composite signal from the composite information signal comprises projecting the composite information signal away from an interfering signal, using interference subspace rejection, to obtain the reduced-interference composite signal.

7. The method of claim 1, further comprising determining the second shared signal correlation data corresponding to the reduced-interference composite signal by calculating a shared data correlation matrix from the reduced-interference composite signal.

8. The method of claim 7, wherein calculating a shared data correlation matrix from the reduced-interference composite signal comprises calculating an impairment correlation matrix for a signal of interest in the reduced-interference composite signal and adding a signal-specific correction term to the impairment correlation matrix to obtain the data correlation matrix.

9. The method of claim 8, wherein calculating an impairment correlation matrix for a signal of interest in the reduced-interference composite signal comprises obtaining de-spread values of the signal of interest corresponding to one or more unused channelization codes of the signal of interest, and estimating impairment correlations from the de-spread values.

10. The method of claim 1, further comprising calculating the second shared signal correlation data corresponding to the reduced-interference composite signal by compensating the first shared signal correlation data to reflect the reduction in interference in the reduced-interference composite signal.

11. The method of claim 10, wherein calculating a reduced-interference composite signal from the composite information signal comprises subtracting signal contributions of a demodulated signal from the composite information signal to obtain the reduced-interference composite signal, and wherein compensating the first shared signal correlation data comprises subtracting a data covariance term corresponding to the subtracted signal contributions from the first shared signal correlation data to obtain the second shared signal correlation data.

12. The method of claim 1, further comprising selecting the first plurality of signals of interest and the second plurality of signals of interest as a function of data rates for the signals of interest.

13. The method of claim 1, further comprising selecting the first plurality of signals of interest and the second plurality of signals of interest as a function of delay requirements for one or more of the signals of interest.

14. The method of claim 1, further comprising detecting first control channel information from the composite information signal, using combining weights calculated from the first shared signal correlation data, and detecting second control channel information from the reduced-interference composite signal, using combining weights calculated from the second shared signal correlation data.

15. A wireless receiver system, said receiver system comprising one or more processing circuits configured to:
compute combining weights for each of a first plurality of signals of interest in a composite information signal as a function of first shared signal correlation data computed from the composite information signal;
calculate a reduced-interference composite signal from the composite information signal; and
compute combining weights for each of a second plurality of signals of interest in the reduced-interference signal as a function of second shared signal correlation data corresponding to the reduced-interference composite signal.

16. The wireless receiver system of claim 15, wherein the one or more processing circuits are configured to calculate the reduced-interference composite signal from the composite information signal by subtracting signal contributions of a demodulated signal from the composite information signal to obtain the reduced-interference composite signal.

17. The wireless receiver system of claim 16, wherein the one or more processing circuits are configured to subtract signal contributions of a demodulated signal from the composite information signal by re-spreading detected bits of the demodulated signal to obtain a cancellation signal and subtracting the cancellation signal from the composite information signal.

18. The wireless receiver system of claim 15, wherein the one or more processing circuits are configured to calculate the reduced-interference composite signal from the composite information signal by projecting the composite information signal away from an interfering signal, using interference subspace rejection, to obtain the reduced-interference composite signal.

19. The wireless receiver system of claim 15, wherein the one or more processing circuits are further configured to determine the second shared signal correlation data corresponding to the reduced-interference composite signal by calculating a shared data correlation matrix from the reduced-interference composite signal.

20. The wireless receiver system of claim 19, wherein the one or more processing circuits are configured to calculate the shared data correlation matrix from the reduced-interference composite signal by calculating an impairment correlation matrix for a signal of interest in the reduced-interference composite signal and adding a signal-specific correction term to the impairment correlation matrix to obtain the data correlation matrix.

21. The wireless receiver system of claim 20, wherein the one or more processing circuits are configured to calculate the impairment correlation matrix for the signal of interest in the reduced-interference composite signal by obtaining de-spread values of the signal of interest corresponding to one or more unused channelization codes of the signal of interest, and estimating impairment correlations from the de-spread values.

22. The wireless receiver system of claim 15, wherein the one or more processing circuits are further configured to calculate the second shared signal correlation data by compensating the first shared signal correlation data to reflect the reduction in interference in the reduced-interference composite signal.

23. The wireless receiver system of claim 22, wherein the one or more processing circuits are configured to calculate the reduced-interference composite signal from the composite information signal by subtracting signal contributions of a demodulated signal from the composite information signal to obtain the reduced-interference composite signal, and to compensate the first shared signal correlation data by subtracting a data covariance term corresponding to the subtracted signal contributions from the first shared signal correlation data to obtain the second shared signal correlation data.

24. The wireless receiver system of claim 15, wherein the one or more processing circuits are further configured to select the first plurality of signals of interest and the second plurality of signals of interest as a function of data rates for the signals of interest.

25. The wireless receiver system of claim 15, wherein the one or more processing circuits are further configured to select the first plurality of signals of interest and the second plurality of signals of interest as a function of delay requirements for one or more of the signals of interest.

26. The wireless receiver system of claim 15, wherein the one or more processing circuits are further configured to detect first control channel information from the composite information signal, using combining weights calculated from the first shared signal correlation data, and to detect second control channel information from the reduced-interference composite signal, using combining weights calculated from the second shared signal correlation data.

27. The wireless receiver system of claim 15, wherein the wireless receiver system comprises a receiver for a wireless network base station.

28. The wireless receiver system of claim 27, wherein the wireless network base station comprises a Wideband-CDMA base station.

29. A wireless receiver system, said receiver system comprising:
a first correlation calculator circuit configured to compute first shared correlation data from a composite information signal;
one or more first receiver circuits configured to compute combining weights for each of a first plurality of signals of interest in the composite information signal, as a function of the first shared signal correlation data;
a signal improver circuit configured to calculate a reduced-interference composite signal from the composite information signal;
a second correlation circuit configured to compute second shared correlation data corresponding to the reduced-interference composite signal; and
one or more second receiver circuits configured to compute combining weights for each of a second plurality of signals of interest in the reduced-interference composite signal, as a function of the second shared signal correlation data.
